(19) United States
(12) Patent Application Publication
(10) Pub. No.: US 2005/0144326 A1
(43) Pub. Date: Jun. 30, 2005

(54) Compartment handling for signaling compression

(76) Inventors: Robert Sugar, Budapest (HU); Zhigang Liu, Coppell, TX (US); Gabor Bajko, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/739,938

(22) Filed: Dec. 19, 2003

Related U.S. Application Data
(60) Provisional application No. 60/527,044, filed on Dec. 5, 2003.

(51) Int. Cl. G06F 15/16

(52) U.S. Cl. 709/247

(57) ABSTRACT

The present invention relates to a method, terminal device, network device and user agent program product for handling a compartment used for compression of signaling messages, wherein a compartment-related information defining at least one of an identification and a handling of the compartment is conveyed in a header of a signaling message between the terminal device and a packet data network. Thereby, it can be made sure that the compartment is uniquely identified and can be opened and/or closed when necessary. Moreover, the need for multiple compartments at a user agent can be eliminated.

### REFERENCE TO RELATED APPLICATION

This application claims priority of U.S. Provisional Patent Application Ser. No. 60/527,044, filed on Dec. 5, 2003, the contents of which are hereby incorporated by reference.

### FIELD OF THE INVENTION

The present invention relates to a method, terminal device, network device, and user agent program product for handling a compartment used for compression of signaling messages.

### BACKGROUND OF THE INVENTION

Many application protocols used for multimedia communications are text-based and engineered for bandwidth-rich links. As a result, messages have not been optimized in terms of size. For example, typical Session Initiation Protocol (SIP) messages range from a few hundred bytes up to two thousand bytes or more. With the planned usage of these protocols in wireless handsets as part of 2.5^{th} generation and 3^{rd} generation cellular networks, the large message size leads to drawbacks. In particular, in connection with the low-rate Internet Protocol (IP) connectivity the transmission delays are significant. Taking into account retransmissions, and the multiplicity of messages that are required in some flows, call setup and feature invocation are adversely affected.

Signaling Compression (SigComp) as defined in the specification RFC 3320 of the Internet Engineering Task Force (IETF) has been developed as a solution for compressing messages generated by application protocols such as SIP or the Real Time Streaming Protocol (RTSP). SigComp provides means to eliminate these problems by offering robust, lossless compression of application messages. In particular, SigComp is offered to applications as a layer between the application and an underlying transport function. The service provided is that of the underlying transport function plus compression. SigComp can be used on top of a wide range of transport protocols including TCP (Transmission Control Protocol), UDP (User Datagram Protocol) and SCTP (Stream Control Transmission Protocol).

When compressing a bidirectional application protocol the choice of using SigComp can be made independently in both directions and compression in one direction does not necessarily imply compression in the reverse direction. Moreover, even when two communication endpoints send SigComp messages in both directions, there is no need to use the same compression algorithm in each direction. It is noted that a SigComp endpoint can decompress messages from multiple remote endpoints at different locations in a network, as the architecture is designed to prevent SigComp messages from one endpoint interfering with messages from a different endpoint. A consequence of this design choice is that it is difficult for a malicious user to disrupt a SigComp operation by inserting false compression messages on the transport layer.

From an application perspective the SigComp layer appears as a new transport functionality with similar behavior to the original transport functionality used to carry uncompressed data. If a particular endpoint whishes to be stateful then it needs to partition its messages into so-called “compartments” under which the state can be saved. SigComp relies on the application to provide this partition. Thus, a compartment can be regarded as an application-specific grouping of messages which relate to a peer endpoint. Depending on the signaling protocol, this grouping may relate to application concepts such as “session”, “dialogue”, “connection”, or “association”. The application allocates state memory on a percompartment basis, and determines when a compartment should be created or closed. A compartment identifier is used as an identifier that uniquely references a compartment. In case of a message-based transport, such as UDP, a SigComp message corresponds to exactly one datagram. For a stream-based transport, such as TCP, the SigComp messages are separated by reserved delimiters.

When the application receives a decompressed message it maps the message to a certain compartment and supplies the compartment identifier to the SigComp functionality. Each compartment is allocated a separate compressor and a certain amount of memory to store a state information. The application must assign distinct compartments to distinct remote endpoints. However, it is possible for a local endpoint to establish several compartments that relate to the same remote endpoint. In this case, reliable stateful operation is possible only if the decompressor does not lump several messages into one compartment when the compressor expected them to be assigned to different compartments.

FIG. 1 shows a schematic diagram indicating a SigComp communication between two endpoints 10, 20, where a signaling protocol sends SigComp messages in both directions in such a manner that a one-to-one relationship is provided between the compartments established by the applications on both ends (“pear compartments”), so that the two endpoints 10, 20 can cooperate more closely. In this case, it is possible to send feedback information that monitors the behavior of an endpoint and helps to improve the overall compression ratio. A compressor function 102 provided at the first endpoint 10 piggybacks a feedback request onto a SigComp message and forwards it to a decompressor function 202 at the second endpoint 20. When the application at the second endpoint 20 receives the decompressed message, it may return the compartment identifier for the message. The decompressor function 202 in the second endpoint 20 forwards the requested feedback data to a state handler function 204 which is responsible for accessing and storing state information once permission is granted by the application. If the decompression function 202 can supply a valid compartment identifier, the state handler function 204 forwards the feedback data to an appropriate compressor function 206 which is used for sending to the endpoint 10. The compressor function 206 returns the requested feedback data to the first endpoint 10 piggybacked onto a SigComp message. This SigComp message is received at the first endpoint 10 by a decompressor function 106 which forwards the decompressed message to the application at the first endpoint 10. Furthermore, the decompressor function 106 forwards the returned feedback data to a state handler function 104 of the first endpoint 10. If the decompressor function 106 can supply a valid compartment identifier, the state handler function 104 forwards the feedback data to the appropriate compressor function 102 used for sending to the second endpoint 20. This compressor function 102 can thus make use of the returned feedback data.

Hence, in order to work correctly, the SigComp functionality needs the application, e.g. SIP, to provide for compartment identifiers as user identities and for means to open and close compartments. However, current SIP specifications do not contain any instructions or guidelines on these issues.

In the Internet Draft “draft-ieff-rohc-sigcomp-sip-00: Applying Signaling Compression (SigComp) to the Session Initiation Protocol (SIP)” SigComp compartments have the same lifetime as SIP sessions, where the compartment identification is based on the SIP dialogue identifier, i.e., the combination of the To tag, From tag, and Call ID. Opening and closing the departments are triggered by the start and the end of the SIP dialogues.

Furthermore, in the Third Generation Partnership Project (3GPP) specification 24.229, Chapter 8, “IP Multimedia Call Control Protocol based on SIP and SDP”, the compartment lifetime was tight to the SIP registration procedure, whereas the compartment identifier was not clearly defined.

One of the problems to be solved is that the user might have several parallel dialogues which need separate compartments. If event notification as described in IETF specification RFC 3265 is used, dialogues are often numerous and long-lived, which is a waste of resources due to the fact that a SigComp compartment generally takes up several kilobytes of memory. Therefore, it would be desirable to have only a small number of compartments for a single user.

Furthermore, initiating a compartment usually involves uploading the decompression code and other useful data for decompression, which compromises the compression efficiency if the compartments are created too often. The above Internet Draft tries to solve this problem by allowing to keep states from previous dialogues, but releasing those states is similar to the compartment closure problem in the general case. Besides, if the dialogue is closed unexpectedly, only one endpoint may be informed that its states are kept.

Furthermore, in the above 3GPP specification 24.229, a working solution for the 3GPP specific SIP environment is described, which however does not provide any solution in the general case. In the 3GPP environment, the outbound proxy, e.g. a P-CSCF (Proxy Call State Control Function) of an IP Multimedia Subsystem (IMS), is aware of registration state changes which could be used to open and close compartments. User identification is also easier, since the P-CSCF is always aware of the Private User Identity, e.g. IMPI, which is unique for a user. IP addresses could also be relied on in many cases for user identification. However, if multiple registrations and SIP forking will be allowed, identification of compartments will be more difficult. Besides, if the users are identified instead of the compartments, there could only be one single compartment for a given user.

SIP only provides for identifying SIP dialogues, but there are not reliable means to identify an endpoint on the SIP level. The content of SIP headers, like “FROM:” cannot be used, since the user may have several public identities, i.e. SIP URIs, used from the same endpoint, and one identity could be used for multiple endpoints at the same time, e.g. in case of SIP forking, where a consumer can be registered from several contact points at the same time. There are also cases, where privacy is requested and the originator of the SIP message is obfuscated.

SigComp messages do not provide any means for compartment identification. Instead, they rely on upper layers for compartment identification. IP addresses could be used as identity in many cases, but there are also limitations existing for that approach. A user might have multiple compartments from one IP address or many users can use the same IP address. Furthermore, a user may whish to send and receive messages on a different IP address or may have multiple IP addresses. The source IP address can be meaningless outside its local domain or IP layer elements, such as Network Address Translators (NAT) are used in the connection path. In summary, IP addresses do not provide general and reliable means to identify compartments.

As another alternative, persistent TCP connections could be used to separate compartments, but many SigComp and SIP are used over UDP, where no persistent connections are defined.

On the other hand, the SigComp functionality relies on upper layers for compartment opening and closure, and in the SIP layer it is hard to foretell when the endpoint stops sending messages. The registration period cannot always be used, because the first proxy that the user contacts, where SigComp is terminated, might not be aware of registration events, and/or the user may still initiate SIP messages without a valid registration. Here also, persistent TCP streams could be used for compartment closing, but again the problem arises that SIP and the SigComp functionality are often used over UDP.

Since none of the above-mentioned solutions is sufficient, the signaling to convey the needed information for compartment identification and compartment handling must be extended.

### SUMMARY OF THE INVENTION

It is therefore an object of the present invention to provide a scheme for improved handling of signaling compression compartments.

This object is achieved by a method of handling a compartment used for compression of signaling messages in packet data network, said method comprising the steps of:
generating at anendpoint a compartment-related information defining at least one of an identification and a handling information of said compartment; and
conveying said compartment-related information in a header of a signaling message to said packet data network.

Furthermore, the above object is achieved by a terminal device for handing a compartment used for compression of signaling messages, and for forwarding said signaling messages to a packet data network, said terminal device being configured to generate a compartment-related information and to incorporate said compartment-related information to a header portion of said signaling message.

Additionally, the above object is achieved by a network device for handling a compartment used for compression of signaling messages, and for routing said signaling messages in a packet data network, said network node being configured to detect a compartment-related information in a header portion of a received signaling message, and to handle a compartment identified by said compartment-related information, based on a compartment handling information included in said compartment-related information.

Finally, the above object is achieved by a user-agent program product comprising code means configured to perform the steps of the above handling method.

Accordingly, compartment handling and identification is performed via header information added to the respective signaling messages. Since the application protocol, such as SIP, may not provide identification of the respective endpoint, the user agent and the terminal device of the respective can take care of it by incorporating the required header information. This way, it is ensured that a compartment is uniquely identified and is opened and/or closed when necessary.

The proposed solution thus allows for using a single compartment for a single endpoint, such that the problem of session-long compartments or registration-long compartments can be solved.

The compartment-related information may be conveyed in the header of the compressed message. In this case, the signaling message used for conveying the compartment-related information already corresponds to the compressed message.

The compartment-related information may be detected at a first-hop network node, and a compartment at the first-hop network node may be handled based on the compartment-related information. Additionally, the compartment-related information may be removed or deleted at the first-hop network node. In particular, the first-hop network node may be an outbound proxy server node to which the endpoint is connected.

The conveying step may comprise conveying the compartment-related information in a header extension of a SIP message. As an example, this header extension may be a private header extension. In particular, the private header extension may be a hop-by-hop header.

As an alternative, the conveying step may comprise conveying the compartment-related information in a source indicator information, e.g. a URI of the header.

The compartment handling information may comprise at least one of a compartment closing instruction, a compartment resetting instruction, and a compartment opening instruction. The compartment opening instruction may be ignored if the related compartment identification already exists for said user at a receiving endpoint. The compartment closing instruction may be conveyed in a SIP Options message. The compartment resetting instruction may only affect signaling messages of one routing direction. In general, a later compartment handling information may overrule an earlier compartment handling information.

The insertion of the compartment-related information to the header may be based on a dialogue identification. Before opening a new compartment, a checking step may be performed for a compartment identification at the other endpoint. The checking step may be based on an analysis of a next-hop address. Based on the checking step, the compartment-related information may then be inserted with a value of a compartment identification detected during the checking step.

A registration contact address may be placed in a contact header of the signaling message, so as to use the same compartment identifier for outgoing and incoming dialogues.

Further advantageous modifications are defined in the dependent claims.

### BRIEF DESCRIPTION OF THE DRAWINGS

The invention will now be described based on a preferred embodiment with reference to the drawings in which:

FIG. 1 shows a schematic block diagram of signaling compression functionalities at first and second endpoints in which the present invention can be implemented;

FIG. 2 shows a schematic diagram of a simple network connection with a compartment handling functionality according to the preferred embodiment;

FIG. 3 shows a private header extension according to the preferred embodiment; and

FIG. 4 shows a signaling diagram of a method of compartment handling according to the preferred embodiment.

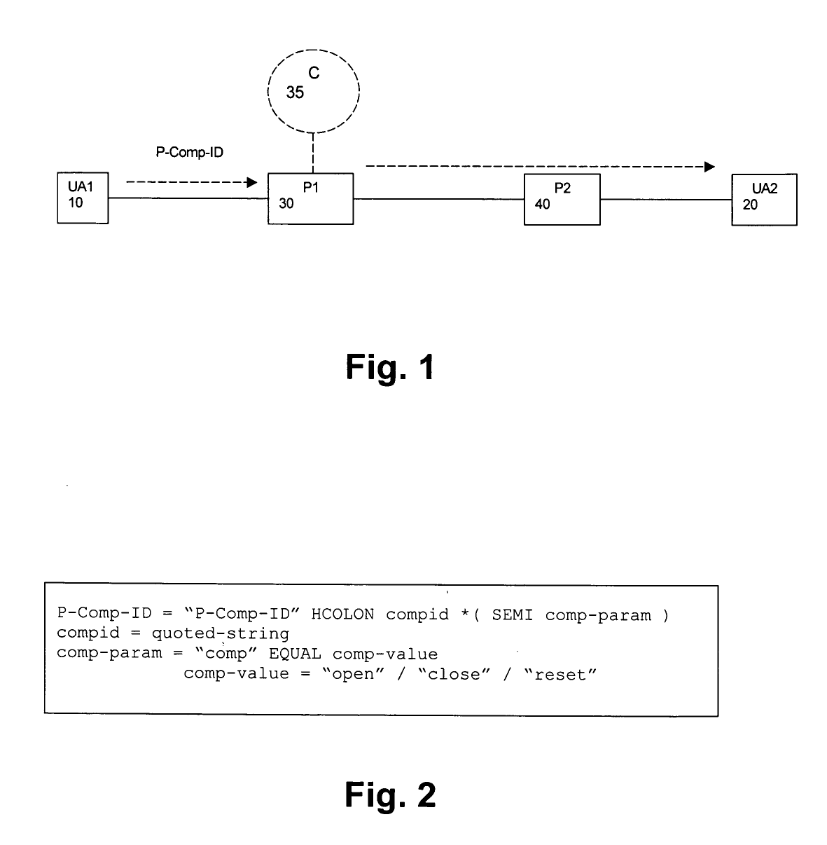

### DESCRIPTION OF THE PREFERRED EMBODIMENT

The preferred embodiment will now be described on the basis of an application of a SigComp functionality in a SIP network environment.

A basic SIP network is composed of four types of elements, namely user agents (UA), proxy servers, redirect servers and registrar servers. UAs typically reside in endpoints or terminal devices, such as IP phones, personal computers or mobile devices. They initiate requests and provide responses. Usually UAs also have an interface to media handling and to the actual application software providing the user interface. Proxy servers are intermediaries, which receive and forward requests providing them with, e.g., routing or other services. Redirect servers simply respond to a request by asking its originator to redirect it to a new address. Registrar servers keep track of the actual points of contact of the consumers by accepting registrations from the UAs. Registrar servers and the SIP registration procedure in general provide user mobility, as the consumer is able to be reachable from any location via a single address. In this sense they resemble a Home Location Register (HLR) functionality in Global System for Mobile Communication (GSM) networks. Each consumer is part of a domain and each domain runs at least one registrar server, which knows a location of its consumers if they are registered.

SIP uses an address format common to Internet Mail, i.e. “user@domain”. The domain part is used to find the correct domain for the consumer, i.e. the Domain Name System (DNS) can be queried for the address via which the SIP registrar within a domain is reachable. The user part is to distinguish between individual consumers within a domain.

Basic SIP includes six messages defining requests or methods. These are INVITE, ACK, OPTIONS, CANCEL, BY and REGISTER. Each request can be responded to with a number of response codes. The most important headers of SIP messages are “Request URI” which defines where it is to be sent next, “To” which contains the recipient or callee address, and “FROM” which contains the sender or caller address.

The OPTIONS request is used to query the capabilities of a UA. CANCEL can be sent to cancel a pending request. BYE is used to terminate an on-going session. REGISTER is send by a subscriber to his registrar server to update his contact information. INVITE is used to set up and modify session. It is a special request that is followed by an ACK after receiving the final response, while other request transactions end at the first final response.

According to the preferred embodiment, at least one of the compartment identification and the compartment handling for the SigComp functionality are provided in a SIP header portion, such as a SIP extension or a URI, which are present in the compressed IP messages. In particular, a new header or header extension “P-Comp-ID:” is defined which contains a unique association between SIP messages and SigComp compartments. The header portion may have additional compartment handling parameters, such as “comp=open”, “comp=close” and “comp=reset” for the respective handling operations.

As the SigComp functionality leaves the compartment handling to upper protocol layers, the SIP level solution is proposed to be designed by extending SIP with the above proposed additional header or header extension, e.g. “P-Comp-ID:”. As an example, the additional header or header portion could be implemented as a private header (P-Header) extension as specified in the IETF specifications RFC 3455. The use of P-Headers provides the advantage that elements can be defined which later could be included in corresponding protocol definitions.

FIG. 2 shows a simplified schematic network environment where a first user agent UA1 provided at the first endpoint 10 is connected via a first proxy 30 and a second proxy 40 to a second user agent (UA2) at a second endpoint 20. In general, user agents are interfaces between the user and the network application. For Web applications, user agents are browsers which allow a user to view Web pages, to navigate in the Web, to provide input to forms, to interact with Java applets, etc. In cases of an electronic mail application, user agents are “mail readers” which allow a user to compose and read messages. In the present case of SIP applications, as already mentioned UAs serve to initiate requests and provide responses, e.g. to carry out calls between the first UA at the endpoint 10 and the second UA at the endpoint 20. UAs can be implemented as software routines coded so as to run on computer units or processing units of terminal devices or endpoints. The first proxy 30 is the home proxy of the first endpoint 10, and the second proxy 40 is the home proxy of the second endpoint 20. If a call is forwarded to the first endpoint 10. It is received by the first proxy 30 and receives treatment such as being proxied to the first endpoint 10 based on the registered contact information. In this case, the first proxy 30 acts as an inbound proxy. On the other hand, if the user at the first endpoint 10 initiates a call, this call is routed to the first proxy 30, which looks up the request URI in the DNLs and sends the call towards its destination. In this case, the first proxy 30 provides the outbound service of DSN resolution and acts as an outbound proxy for this call. On any call there may be any number of inbound and outbound proxy services. Some proxies may even provide both sorts for a single call.

According to FIG. 2, the new header information P-Comp-ID is forwarded in the header of the signaling message from the session or call initiating endpoint, e.g. the first endpoint 10, to its first outbound proxy, e.g. the first proxy 30, to provide the required compartment identification and handling information to this proxy. Based on this compartment identification and handling information, the first proxy 30 may open a new compartment 35 which can be used for providing the SigComp functionality towards the second endpoint 20.

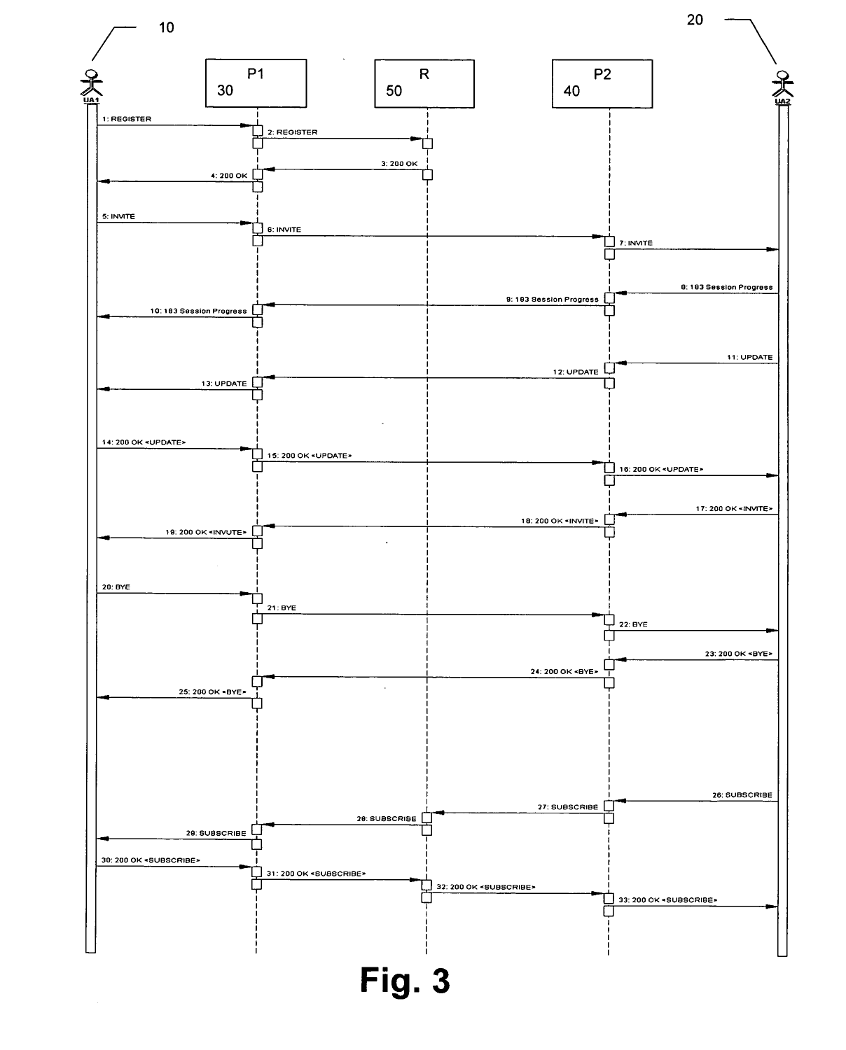

FIG. 3 shows an example of the new P-Header in the so-called Augmented Back-us-Naur Form (ABNF) of header definition. As can be gathered from this header definition, a parameter “comp” with allocated parameter values “open”, “close”, and “reset” is defined in this new P-Header. These parameter values are used for signaling compartment handling towards the network.

Examples of such new header entries are:
P-Comp-ID: “Trillian”; comp=open
P-Comp-ID: “VGhhbmtzlGZvciB0aGUgZmlzaCE=”; comp=close
P-Comp-ID: “sip:user@operator1.com:proxy.operator2.com:3265971756”

The new header P-Comp-ID may be a hop-by-hop header as defined in the IETF specification RFC3261, which is removed by the first proxy that encounters it, e.g. the first proxy 30 in FIG. 2.

The new header P-Comp-ID should be present in all compressed messages. It is allowed to send a compressed message without a valid compartment, but this message will not be able to save states or make announcements. However, such messages should then use a default identifier. In this case, no open or close parameters can be used for the default identifier.

The new header or header extension might be sent in uncompressed messages, for example to signal the need to reset or close the compartment in case decompression of SigComp messages fails. The value of the new header or header extension will be set by the endpoint that sends the first compressed messages inside that compartment. During the compartments first usage, the “comp=open” parameter should be present to create the compartment at the other end as well. In particular, the value of the new header or header extension might uniquely identify the compartment, for example by combining the Fully Qualified Domain Name (FQDN) of the two endpoints and the compartment creation time to form the compartment identifier.

The “comp=open” parameter indicates that a new compartment should be opened for that user. The sending endpoint should also make sure to create a compartment with the same compartment identifier to allow SigComp traffic in the opposite direction as well. It may be sent by any of the endpoints at any time, but could appear in the first message initiated by the user. If a compartment already exists for that user with the same compartment identifier, the “comp=open” parameter will be ignored. However, if the compartment identifier is different, a new compartment will be opened for that user.

The “comp=close” parameter indicates that the user does not wish to send or receive any compressed messages in that compartment. The endpoints should keep the compartment open until the dialogue closes and the SIP timers expire for possible responses, retransmissions or race conditions. The sending endpoint should not send any further messages inside the compartment. The receiving endpoint may send messages in the same compartment, for example if it responds to a request containing the “comp=close” parameter.

If the user does not whish to communicate in that compartment anymore, the compartment can be closed and the other endpoint should be explicitly informed. This could be achieved for example by sending an OPTIONS message with a “comp=close” parameter to the other endpoint.

If a “comp=open” parameter is received after a “comp=close” parameter with the same compartment identifier, the compartment could be reopened. If a compartment closure is pending, a receipt of a “comp=open” parameter cancels the compartment closure. In both cases, the endpoint sending the “comp=open” parameter after the “comp=close” parameter should not rely on any previously saved data and act as if the compartment was newly opened.

The “comp=reset” parameter means that the sending endpoint encountered some critical error. In this case, the receiving endpoint must not rely on any previously saved states, should re-announce its capabilities and act as if the compartment was just opened. Unlike the “comp=open” and “comp=close” parameters, the “comp=reset” parameter only effects the messages in one direction and has no effect on the compartment at the receiving endpoint.

One SIP dialogue should only correspond to one compartment, even if multiple compartments exist for that user. This way, the compartment identifier could be tied to the dialogue identifier triplet, i.e. Call-ID, To-tag, From-tag, to thereby base the insertion of the new header or header portion on the dialogue identification. If a new dialogue is initiated, any of the opened compartments could be used, or a new compartment could be created. If a message is to be sent in compressed form, the compartment identifier for that dialogue should be checked first. If there is none yet, the URI could be examined for open compartments towards that endpoint. If none of these exists or the endpoint does not wish to use the previous ones, a new compartment can be opened.

When a new dialogue is initiated, the endpoint could use the existing compartments towards the other endpoint to reduce the number of opened compartments. This could be achieved by analyzing the next-hop URI. If a compartment already exists for that URI, the new header P-Comp-ID could be inserted with that value, e.g., compartment identifier. In many cases, the endpoint will be aware of existing compartments by other means, for example if the user always communicates through the same outbound proxy. If the user wishes to use the same compartment identifier for outgoing and incoming dialogues, it should place its registration contact URI in the Contact header of the first compressed message of the dialogue. Thus, the proxy, e.g. the first proxy 30, could match the URI and the corresponding compartment identifier with the request-URI of a user terminated dialogue.

In the following, an example of a signalling procedure according to the preferred embodiment is described.

FIG. 3 shows a schematic signalling diagram where arrows indicate transfers of signalling messages between the network elements indicated in the upper portion of FIG. 3, which are based on FIG. 2. The procedure proceeds from the upper first arrow to the lower last arrow.

In step one, the first UA at the first endpoint 10, which may be a user equipment (UE), sends a REGISTER to its outbound proxy, e.g. the first proxy 30. It is configured so that it knows that the proxy supports the compression and the message will be send in a new compartment. This message may look as follows:
REGISTER sip:home.domain.com SIP/2.0
. . .
Via: SIP/2.0/UDP 192.0.2.4:5060;branch=z9hG4bK2bo02b; comp=sigcomp
Contact: <sip:user1@192.0.2.4; comp=sigcomp>
P-Comp-ID: “compid1”; comp=open
. . .

In step 2, the first proxy 30 decompresses a message and opens the compartment. It binds the compartment identifier to the contact address(es) and to the REGISTER transaction. Then, the REGISTER is forwarded to a dedicated registrar server 50. The P-Comp-ID header is removed. Thereafter, in step 3, the registrar server 50 registers the contact URI with “comp=sigcomp” and returns a 200 OK Message. In step 4, the first proxy 30 forwards the 200 OK response to the user agent at the first endpoint 10. It will be sent compressed in the compartment saved for this transaction. This message may look as follows:
SIP/2.0 200 OK
. . .
Via: SIP/2.0/UDP 192.0.2.4:5060;branch=z9hG4bK2boO2b; comp=sigcomp
P-Comp-ID: “compid1”
. . .

In step 5, the first endpoint 10 invites the second endpoint 20 to a session. It wishes to open a new compartment for the session. It is noted that the described generation of a new department is not necessary and is mainly described here for demonstrating how to handle multiple compartments. Of course, the first user agent at the first endpoint 10 could have used the previous compartment as well. The session initiation message INVITE could look as follows:
INVITE sip:ua2@other.domain.com SIP/2.0
. . .
Via: SIP/2.0/UDP 192.0.2.4:5060;branch=z9hG4bK2boO2b; comp=sigcomp
Contact: <sip:user1@192.0.2.4; comp=sigcomp>
P-Comp-ID: “compid2”: comp=open
. . .

In step 6, the first proxy 30 removes the P-comp-ID header and forwards the request to the second proxy 40. It opens a new compartment and binds the received compartment identifier “compid2” to the dialogue. Then, in step 7, the second proxy 40 proxies the INVITE message to the second user agent at the second endpoint 20. In step 8, the second user agent responds with a 183 Session Progress response. This response is forwarded in step 9 to the first proxy 30. In step 10, the first proxy compresses the request using the “compid2” compartment. The compressed request may look as follows:
SIP/2.0 183 Session Progress
. . .
Via: SIP/2.0/UDP 192.0.2.4:5060;branch=z9hG4bKtimmaaah; comp=sigcomp P-Comp-ID: “compid2”

In step 11, the second user agent at the second endpoint 20 sends a subsequent request, which is forwarded in step 12 by the second proxy 40 to the first proxy 30. In step 13, the first proxy 30 checks the compartment for the dialogue and sends the message to the first user agent at the first endpoint 10 in compressed form using the compartment identifier “compid2”. This compressed message may be an UPDATE message which may look as follows:
UPDATE sip:user1@192.0.2.4; comp=sigcomp SIP/2.0
Route: <sip:user1@192.0.2.4; comp=sigcomp; Ir>
P-Comp-ID: “compid2”
. . .

The first user agent at the first endpoint 10 responds in step 14 with a 200 OK message which is compressed using the compartment identifier “compid2”. This response message is forwarded in step 15 to the second proxy 40, and in step 16 to the second user agent at the second endpoint 20. In step 17, the second user agent at the second endpoint 20 responds to the earlier INVITE message with a 200 OK response. This response is forwarded in step 18 to the first proxy 30, and in step 19 to the first user agent in compressed form using the compartment identifier “compid2”. In step 20, the first user agent ends the session. It wishes to close the compartment as well. However, it does not physically delete the compartment until the dialogue itself closes allowing responses and retransmissions to go through. The corresponding BYE message may look as follows:
BYE sip:ua2@other.domain.com SIP/2.0
Via: SIP/2.0/UDP 192.0.2.4:5060;branch=z9hG4bK2bo02b; comp=sigcomp
P-Comp-ID: “compid2”; comp=close
. . .

In step 21, the BYE message is forwarded to the second proxy 40. The compartment is not closed yet. In step 22, the BYE message is proxied to the second user agent at the second endpoint 20, which responds in step 23 with a 200 OK message. This response message is forwarded in step 24 to the first proxy 30. The first proxy 30 may still use the compartment identifier “compid2” for that dialogue in step 25. Then, it compresses the message inside that compartment. When the retransmission timer expires, it closes the compartment, just as the first user agent at the first endpoint 10.

At a later point in time, the second user agent at the second endpoint 20 initiates a new dialogue towards the first user agent at the first connection end 10 in step 26. In step 27, the corresponding SUBSCRIBE message is send to the registrar server 50 of the first user agent. This registrar server 50 forwards the request to the outbound proxy, e.g. the first proxy 30 of the first user agent in step 28. In step 29, the first proxy 30 determines that the next hop URI contains the “comp=sigcomp” parameter so that the SUBSCRIBE message is to be send in a compressed form. It looks up the URI and finds the compartment identifier “compid1” as the only open compartment for that URI. Hence, the first proxy 30 uses that compartment to compress the message and binds it to the dialogue. It is noted that if no compartment identifier had been found by the first proxy 30, a new compartment would have been created. The corresponding SUBSCRIBE message may look as follows:
SUBSCRIBE sip:user1@192.0.2.4; comp=sigcomp SIP/2.0
. . .
P-Comp-ID: “compid1”
. . .

In step 30, the first user agent at the first endpoint 10 responds with a 200 OK message using the compartment identifier “compid1” for compression. This response message is proxied back in steps 31 to 33 the same route as the original request.

According to a second preferred embodiment, which relates to an alternative solution, it is possible as well to insert the compartment identifier and compartment handling parameters or commands in URIs along with the parameter “comp=SigComp”, if the SIP compressing specification RFC3486 is supported. The newly defined URI parameters may appear only when the “comp=sigcomp” parameter is present. The new parameters may be “compid=“ . . . opaque_value . . . ”” and “compop=operation” where the value “operation” could be set to “open”, “close”, or “reset”.

An example of such a modified URI may look as follows:

### EXAMPLE

Via: SIP12.0/UDP 192.0.2.4:5060;branch=z9hG4bK2b02b; comp=sigcomp; compid=“Trillian”; comp=open

A difference between the solution according to the first preferred embodiment and the alternative solution according to the second preferred embodiment resides in that the P-Comp-ID header strictly travels between the two hops using that compartment, while the new URI parameters appear everywhere where that URI is used, e.g. as registered contacts, Record-Route and Via elements. Since the new parameters travel along with the “comp=sigcomp” parameter, SIP routing mechanisms ensure that those URI parameters are only used in compression when the message is sent between the relevant endpoints. The only exception is the Contact header, especially in registration contacts, because the user does not know in advance when and who will contact him. Therefore, URIs in Contact headers must not contain the “compid” or “compop” parameters. Instead, the other endpoint, e.g. the first proxy 30 in FIG. 2, should open the compartment or choose an existing compartment identifier, when the user is actually contacted.

It is noted that the present invention is not restricted to the above SIP environment and the SigComp functionality, but can be used in any network environment where a signaling compression functionality using compartments or similar application-specific groupings of messages is provided. Furthermore, any kind of header or header extension can be used for transferring or signalling the compartment identification and/or compartment handling information. The preferred embodiments may thus vary within the scope of the attached claims.

1. A method of handling a compartment used for compression of signaling messages in a packet data network, said method comprising the steps of:
a) generating at an endpoint a compartment-related information defining at least one of an identification and a handling of said compartment; and
b) conveying said compartment-related information in a header of a signaling message to said packet data network.

2. A method according to claim 1, wherein said signaling message is a compressed message.

3. A method according to claim 1, further comprising the step of detecting said compartment-related information at a first-hop network node, and handling a compartment at said first-hop network node based on said compartment-related information.

4. A method according to claim 3, further comprising the step or removing said compartment-related information at said first-hop network node (30).

5. A method according to claim 3, wherein said first-hop network node (30) is an outbound proxy server node.

6. A method according to claim 1, wherein said conveying step comprises conveying said compartment-related information in a header extension of a SIP message.

7. A method according to claim 6, wherein said header extension is a private header extension.

8. A method according to claim 7, wherein said private header extension is a hop-by-hop header.

9. A method according to claim 1, wherein said conveying step comprises conveying said compartment-related information in a resource indicator information of said header.

10. A method according to claim 1, wherein said compartment handling information comprises at least one of a compartment closing instruction, a compartment resetting instruction, and a compartment opening instruction.

11. A method according to claim 10, wherein said compartment opening instruction is ignored if the related compartment identification already exists for that user at a receiving endpoint.

12. A method according to claim 10, wherein said compartment closing instruction is conveyed in a SIP Options message.

13. A method according to claim 10, wherein said compartment resetting instruction only affects signaling messages of one routing direction.

14. A method according to claim 10, wherein a later compartment handling information overrules an earlier compartment handling information.

15. A method according to claim 1, further comprising the step of inserting said compartment-related information to said header based on a dialogue identification.

16. A method according to claim 15, further comprising the step of checking for a compartment identification at the other endpoint before opening a new compartment.

17. A method according to claim 16, wherein said checking step is based on a analysis of a next-hop address.

18. A method according to claim 16, further comprising the step of inserting said compartment-related information with a value of a compartment identification detected during said checking step.

19. A method according to claim 1, further comprising the step of placing a registration contact address in a contact header of said signaling message, so as to use the same compartment identifier for outgoing and incoming dialogues.

20. A terminal device for handling a compartment used for compression of signaling messages, and for forwarding said signaling messages to a packet data network, said terminal device being configured to generate a compartment-related information and to incorporate said compartment-related information to a header portion of said signaling message.

21. A terminal device according to claim 20, wherein said terminal device is a user equipment connected to said packet data network via a cellular communication network.

22. A network device for handling a compartment used for compression of signaling messages, and for routing said signaling messages in a packet data network, said network node being configured to detect a compartment-related information in a header portion of a received signaling message, and to handle a compartment identified by said compartment-related information, based on a compartment handling information included in said compartment-related information.

23. A device according to claim 22, wherein said network device is configured to generate a new compartment based on said compartment-related information and to delete said compartment-related information from said signaling message.

24. A device according to claim 22, wherein said network device is an outbound proxy of an endpoint at which said signaling message was generated.

25. A user agents program product comprising code means configured to perform the steps of claim 1 when loaded to a memory of a code processing means of a terminal device.
